(19) United States
(12) Patent Application Publication
(10) Pub. No.: US 2011/0076434 A1
(43) Pub. Date: Mar. 31, 2011

(54) ADHESIVE TAPE, MOBILE TERMINAL INCLUDING THE SAME, AND MANUFACTURING METHOD AND APPARATUS OF MOBILE TERMINAL

(76) Inventors: Donghyuk CHO, Seoul (KR); Minho Park, Seoul (KR); Youngmin Kim, Seoul (KR)

(21) Appl. No.: 12/892,054

(22) Filed: Sep. 28, 2010

(30) Foreign Application Priority Data
Sep. 29, 2009 (KR) 10-2009-0092584

(51) Int. Cl. H04M 1/00; C09J 7/02; B32B 15/04; B32B 7/12; H04B 1/38; B29C 65/14

(52) U.S. Cl. 428/38; 428/344; 428/457; 428/137; 156/272.2; 156/379.6

(57) ABSTRACT

An adhesive tape that bonds components through thermal fusion based on induction heating, a mobile terminal including the same, and a manufacturing method and apparatus of the mobile terminal are disclosed. The mobile terminal includes a nonmetal case forming an external appearance of the mobile terminal, a nonmetal member bonded to the case, and an adhesive tape for bonding the member to the case. The adhesive tape includes a metal sheet configured to be high-frequency induction heated and thermal fusion tape parts stacked on opposite main surfaces of the metal sheet such that the thermal fusion tape parts can be thermally fused to the case and the member by the heated metal sheet.

### CROSS-REFERENCE TO RELATED APPLICATION

This application claims the priority benefit of Korean Patent Application No. 10-2009-0092584, filed on Sep. 29, 2009 in the Korean Intellectual Property Office, the disclosure of which is incorporated herein by reference.

### BACKGROUND OF THE INVENTION

1. Field of the Invention

The present invention relates to an adhesive tape, a mobile terminal including the same, and a manufacturing method and apparatus of the mobile terminal, and more particularly to an adhesive tape that bonds components through thermal fusion based on induction heating, a mobile terminal including the same, and a manufacturing method and apparatus of the mobile terminal.

2. Description of the Related Art

A mobile terminal is a portable device having at least one of functions including a function to perform voice and video communication, a function to input and output information, and a function to store data. With increasing functional diversification, such a mobile terminal now has complex functions, such as capture of a still image or a moving image, playback of a music file or a moving image file, gaming, reception of broadcasting, wireless Internet, and the like. That is, the mobile terminal also functions as a multimedia player.

Also, the mobile terminal is regarded as a personal belonging that expresses personality of a user, with the result that the mobile terminal is required to be manufactured in various designs. Examples of such designs may include a bar type structure, a slide type structure, a folder type structure, a swivel type structure, and the like.

To maintain and increase functions of the mobile terminal, it may be considered to improve a structural component of the mobile terminal or to propose a new structure of the mobile terminal. In this case, a new manufacturing method of the mobile terminal is required.

### SUMMARY OF THE INVENTION

Therefore, the present invention has been made in view of the above problems, and it is an object of the present invention to provide an adhesive tape exhibiting high adhesive strength necessary to bond components of a mobile terminal and a mobile terminal including the same.

It is another object of the present invention to provide a manufacturing method and apparatus of a mobile terminal in which adhesive strength between components of the mobile terminal is high.

In accordance with an aspect of the present invention, the above and other objects can be accomplished by the provision of an adhesive tape including a metal sheet configured to be high-frequency induction heated and thermal fusion tape parts stacked on opposite main surfaces of the metal sheet such that the thermal fusion tape parts can be thermally fused to predetermined members by the heated metal sheet.

In accordance with another aspect of the present invention, there is provided a mobile terminal including a nonmetal case forming an external appearance of the mobile terminal, a nonmetal member bonded to the case, and an adhesive tape for bonding the member to the case, wherein the adhesive tape includes a metal sheet configured to be high-frequency induction heated and thermal fusion tape parts stacked on opposite main surfaces of the metal sheet such that the thermal fusion tape parts can be thermally fused to the case and the member by the heated metal sheet.

In accordance with another aspect of the present invention, there is provided a manufacturing method of a mobile terminal, including disposing an adhesive tape between predetermined members, applying a high frequency to the adhesive tape to induction heat the adhesive tape, and thermally fusing the heated adhesive tape to the members.

In accordance with yet another aspect of the present invention, there is provided a manufacturing apparatus of a mobile terminal, including a high frequency generation device for applying a high frequency to an adhesive tape in a state in which the adhesive tape is disposed between predetermined members to heat the adhesive tape and a pressing device for applying pressure to the members when the adhesive tape is heated and thermally fused to the members.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a mobile terminal according to an embodiment of the present invention;

FIG. 2 is a perspective view illustrating the front of a mobile terminal according to an embodiment of the present invention;

FIG. 3 is a perspective view illustrating the rear of the mobile terminal according to the embodiment of the present invention shown in FIG. 2;

FIG. 4 is a partial sectional view illustrating a case of the mobile terminal according to the embodiment of the present invention;

FIG. 5 is a construction view illustrating an adhesive tape of the mobile terminal according to the embodiment of the present invention;

FIG. 6 is a view illustrating a manufacturing apparatus of the mobile terminal according to the embodiment of the present invention; and

FIG. 7 is a flow chart illustrating a manufacturing method of the mobile terminal according to the embodiment of the present invention.

### DETAILED DESCRIPTION OF THE PREFERRED EMBODIMENTS

Exemplary embodiments of the present invention will be described with reference to the attached drawings. The terms “module” and “unit,” when attached to the names of components are used herein to help the understanding of the components and thus they should not be considered as having specific meanings or roles. Accordingly, the terms “module” and “unit” may be used interchangeably.

A mobile terminal as described in this specification may include a mobile phone, a smart phone, a laptop computer, a digital broadcast terminal, a personal digital assistant (PDA), a portable multimedia player (PMP), and a navigator.

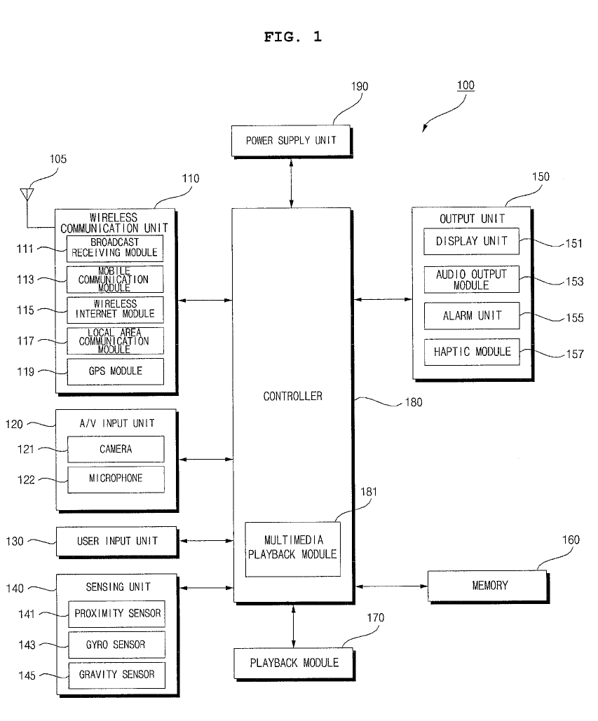

FIG. 1 is a block diagram illustrating a mobile terminal according to an embodiment of the present invention. The mobile terminal according to this embodiment of the present invention will be described below with reference to FIG. 1 in terms of functional components thereof.

Referring to FIG. 1, a mobile terminal 100 may include a wireless communication unit 110, an audio/video (A/V) input unit 120, a user input unit 130, a sensing unit 140, an output unit 150, a memory 160, an interface unit 170, a controller 180, and a power supply unit 190. In actual implementation, two or more of these components may be incorporated into a single component, or one component may be configured separately as two or more components, as needed.

The wireless communication unit 110 may include at least one module that enables wireless communication between the mobile terminal 100 and a wireless communication system or between the mobile terminal 100 and a network within which the mobile terminal 100 is located. For example, the wireless communication unit 110 may include a broadcast receiving module 111, a mobile communication module 113, a wireless Internet module 115, a local area communication module 117, and a global positioning system (GPS) module 119.

The broadcast receiving module 111 receives a broadcast signal and/or broadcasting-related information from an external broadcast management server through a broadcast channel. The broadcast channel may be a satellite channel, a terrestrial channel, or the like. The broadcast management server may be a server that generates and transmits a broadcast signal and/or broadcasting-related information or a server that receives a generated broadcast signal and/or generated broadcasting-related information and transmits the generated broadcast signal and/or the generated broadcasting-related information to a terminal.

The broadcasting-related information may be information related to a broadcast channel, a broadcast program, or a broadcast service provider. The broadcast signal may not only include a TV broadcast signal, a radio broadcast signal, or a data broadcast signal but also a broadcast signal in which a data broadcast signal is combined with a TV broadcast signal or a radio broadcast signal. The broadcasting-related information may also be provided through a mobile communication network. In this case, the broadcasting-related information may be received by the mobile communication module 113. The broadcasting-related information may be provided in various forms. For example, the broadcasting-related information may be provided in the form of an electronic program guide (EPG) of digital multimedia broadcasting (DMB) or an electronic service guide (ESG) of digital video broadcast-handheld (DVB-H).

The broadcast receiving module 111 receives a broadcast signal using a variety of broadcast systems. Specifically, the broadcast receiving module 111 may receive a digital broadcast signal using a digital broadcast system, such as digital multimedia broadcasting-terrestrial (DMB-T), digital multimedia broadcasting-satellite (DMB-S), media forward link only (MediaFLO), digital video broadcast-handheld (DVB-H), or integrated services digital broadcast-terrestrial (ISDB-T). Also, the broadcast receiving module 111 may be configured to be suitable not only for such a digital broadcast system but also for any other broadcast system that provides a broadcast signal. A broadcast signal and/or broadcasting-related information received through the broadcast receiving module 111 may be stored in the memory 160.

The mobile communication module 113 transmits and receives a wireless signal to and from at least one selected from a group consisting of a base station, an external terminal, and a server over a mobile communication network. The wireless signal may include a voice call signal, a video call signal, or various types of data associated with transmission and reception of a text/multimedia message.

The wireless Internet module 115 is an internal or external module for wireless Internet access which may be provided to the mobile terminal 100. The wireless Internet module 115 may use wireless Internet technology, such as wireless LAN (WLAN) (Wi-Fi), wireless broadband (WiBro), world interoperability for microwave access (WiMAX), or high speed downlink packet access (HSDPA).

The local area communication module 117 is a module for local area communication. For example, Bluetooth, radio frequency identification (RFID), infrared data association (IrDA), ultra wideband (UWB), or ZigBee may be used as local area communication technology.

The GPS module 119 is a module configured to acquire a location of the mobile terminal 100. The GPS module 119 receives location information from a plurality of GPS satellites.

The A/V input unit 120 is provided to input an audio signal or a video signal. The A/V input unit 120 may include a camera 121 and a microphone 123. The camera 121 processes an image frame, such as a still image or a moving image, obtained through an image sensor in a video communication mode or an image capture mode. The processed image frame may be displayed on the display unit 151.

The image frame processed by the camera 121 may be stored in the memory 160 or may be transmitted to the outside through the wireless communication unit 110. Two or more cameras 121 may be provided depending on how the mobile terminal is constructed.

The microphone 123 receives an external audio signal in a communication mode, a record mode, or a voice recognition mode and processes the received audio signal into electrical audio data. In the communication mode, the processed audio data may be converted into a form transmittable to a mobile communication base station through the mobile communication module 113. A variety of noise removal algorithms may be used to remove noise generated in the course of receiving an external audio signal through the microphone 123.

The user input unit 130 generates key input data corresponding to a key input operation that a user has performed to control the operation of the mobile terminal. The user input unit 130 may include a keypad, a dome switch, a (resistive/capacitive) touchpad, a jog wheel, a jog switch, a finger mouse, or the like. In a case in which the touchpad constitutes a layered structure with the display unit 151, which will be described later, the touchpad may be referred to as a “touch screen.”

The sensing unit 140 detects a current state of the mobile terminal 100, such as whether the mobile terminal 100 is opened or closed, where the mobile terminal 100 is located, or whether or not the user has contacted the mobile terminal 100, and generates a sensing signal for controlling the operation of the mobile terminal 100. For example, the sensing unit 140 may sense whether the mobile terminal 100 is open or closed in a slide manner in a case in which the mobile terminal 100 is a slide phone. Also, the sensing unit 140 may also be responsible for sensing functions associated with whether or not power is supplied to the power supply unit 190 or whether or not the interface unit 170 is coupled to an external device.

The sensing unit 140 may include a proximity sensor 141. The proximity sensor 141 can detect the presence or absence of an object that is approaching or near to the mobile terminal 100 without physical contact. The proximity sensor 141 can detect a nearby object based on a change in AC magnetic fields or a change in magnetostatic fields or based on a variation rate of capacitance. Examples of the proximity sensor 141 may include a transmissive photoelectric sensor, a direct reflective photoelectric sensor, a mirror reflective photoelectric sensor, a high frequency oscillation proximity sensor, a capacitive proximity sensor, a magnetic proximity sensor, an infrared proximity sensor, or the like. Two or more proximity sensors 141 may be provided depending on how the mobile terminal is constructed.

The sensing unit 140 may include a gyro sensor 142. The gyro sensor 142 may include a sensor for sensing movement of an object using a gyroscope, an inertia sensor, and an acceleration sensor. The gyroscope may include a mechanical gyroscope, a loop type laser gyroscope, an optical fiber gyroscope, or the like. The gyro sensor 142 senses movement of the mobile terminal to provide a signal for controlling the mobile terminal.

The sensing unit 140 may include a gravity sensor 143. The gravity sensor 143 may include all kinds of sensors that can sense a rotation state of the mobile terminal. The gravity sensor 143 can sense a current rotation state of the mobile terminal based on a change in resistance of a variable resistor, to which a weight is connected, during rotation of the mobile terminal or based on a direction in which a conductive object, which is disposed in the center of the mobile terminal, contacts the mobile terminal during rotation of the mobile terminal.

The output unit 150 is provided to output an audio signal, a video signal, or an alarm signal. The output unit 150 may include the display unit 151, an audio output module 153, an alarm unit 155, and a haptic module 157.

The display unit 151 displays information processed in the mobile terminal 100. For example, in a case in which the mobile terminal 100 is in a communication mode, the display unit 151 displays a communication-related user interface (UI) or graphical user interface (GUI). In a case in which the mobile terminal 100 is in a video communication mode or an image capture mode, the display unit 151 may individually or simultaneously display captured or received images. Also, the display unit 151 may display a corresponding UI or GUI.

In a case where the display unit 151 forms a layered structure together with the touchpad so as to construct a touch screen as described above, the display unit 151 may not only be used as an output device but may also be used as an input device. In a case where the display unit 151 is embodied as a touch screen, the display unit 151 may include a touch screen panel, a touch screen panel controller, and the like. The touch screen panel is a transparent panel externally attached to the mobile terminal 100. The touch screen panel may be connected to an internal bus of the mobile terminal 100.

The touch screen panel may be configured to convert pressure applied to a specific region of the display unit 151 or change of capacitance generated at the specific region of the display unit 151 into an electric input signal. The touch screen panel may be configured to not only detect touch position and touch area but also to detect touch pressure.

The touch screen panel monitors touches and sends, upon detecting a touch input, corresponding signals to the touch screen panel controller. The touch screen panel controller processes the signals and transmits the resulting data to the controller 180. The controller 180 determines whether or not touch input has occurred and which region of the touch screen has been touched.

The display unit 151 may include at least one selected from a group consisting of a liquid crystal display, a thin film transistor-liquid crystal display, organic light-emitting diodes (OLED), a flexible display, and a three-dimensional display (3D display).

Some of the above-specified displays may be configured in a transparent structure or in an optical transmissive structure such that one can see through the screen and out the back of the display. Such displays may be referred to as transparent displays. A representative example of the transparent displays may be transparent OLED (TOLED). The rear of the display unit 151 may be configured in an optical transmissive structure. In this structure, it is possible for a user to see things behind a mobile terminal body through a region, occupied by the display unit 151, of the mobile terminal body.

Two or more display units 151 may be provided depending on how the mobile terminal 100 is constructed. For example, the mobile terminal 100 may include both an external display unit (not shown) and an internal display unit (not shown).

The audio output module 153 outputs audio data received from the wireless communication unit 110 or stored in the memory 160 when the mobile terminal 100 is in an incoming call mode, a communication mode, a record mode, a voice recognition mode, or a broadcast receiving mode. Also, the audio output module 153 outputs audio signals associated with functions performed by the mobile terminal 100, for example, an audio signal associated with an incoming call sound or a message received sound. The audio output module 153 may include a receiver, a speaker, a buzzer, or the like.

The alarm unit 155 outputs a signal notifying the user that an event has occurred in the mobile terminal 100. Examples of the event occurring in the mobile terminal 100 include incoming call reception, message reception, and key signal input. The alarm unit 155 outputs a signal notifying the user of the occurrence of an event in a different form from an audio signal or a video signal. For example, the alarm unit 155 may output a notification signal through vibration. When an incoming call signal is received or when a message is received, the alarm unit 155 may output a signal indicating the reception of the incoming call signal or the message. Also, when a key signal is input, the alarm unit 155 may output a feedback signal to the key signal input. A user can perceive the event occurrence through the signal output from the alarm unit 155. Of course, the signal indicating the event occurrence may also be output through the display unit 151 or the audio output module 153.

The haptic module 157 generates a variety of tactile effects which the user can sense. One typical example of the tactile effects that can be generated by the haptic module 157 is vibration. In a case where the haptic module 157 generates vibration as a tactile effect, the haptic module 157 may change intensity and pattern of generated vibration. Also, the haptic module 157 may combine different vibrations and output the combined vibration, or may sequentially output different vibrations.

In addition to vibration, the haptic module 157 may generate various tactile effects, such as a stimulus effect by an arrangement of pins that move perpendicularly to the touched skin surface, a stimulus effect by air blowing or suction through an air outlet or inlet, a stimulus effect through brushing of the skin surface, a stimulus effect through contact with an electrode, a stimulus effect using electrostatic force, and a stimulus effect through reproduction of thermal (cool/warm) sensation using an endothermic or exothermic element. The haptic module 157 may be implemented so as to allow the user to perceive such effects not only through direct tactile sensation but also through kinesthetic sensation of fingers, arms, or the like of the user. Two or more haptic modules 157 may be provided depending on how the mobile terminal 100 is constructed.

The memory 160 may store a program based on which the controller 180 perform a processing and controlling operation. Also, the memory 160 may temporarily store input or output data items (for example, a phonebook, messages, still images, moving images, and the like).

The memory 160 may include at least one of storage media including a flash memory type memory, a hard disk type memory, a multimedia card micro type memory, a card memory type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc. Also, the mobile terminal 100 may utilize web storage that performs a storage function of the memory 160 over the Internet.

The interface unit 170 functions to interface with all external devices connected to the mobile terminal 100. Examples of the external devices connected to the mobile terminal 100 include a wired/wireless headset, an external battery charger, a wired/wireless data port, a memory card, a card socket such as a subscriber identification module/user identity module (SIM/UIM) card socket, an audio input/output (I/O) terminal, a video I/O terminal, and an earphone. The interface unit 170 may receive power or data from such an external device and provide the same to each internal component of the mobile terminal 100. Also, the interface unit 170 may transmit internal data of the mobile terminal 100 to the external device.

When the mobile terminal 100 is connected to an external cradle, the interface unit 170 may be used as a channel through which the connected cradle supplies power to the mobile terminal 100 or a channel through which a variety of command signals input to the cradle by a user are transferred to the mobile terminal 100. The various command signals or the power input from the cradle may function as a signal for enabling the user to perceive that the mobile terminal is correctly mounted in the cradle.

The controller 180 generally controls the operation of each component to control the overall operation of the mobile terminal 100. For example, the controller 180 performs control and processing associated with voice communication, data communication, video communication, and the like. The controller 180 may include a multimedia playback module 181 for multimedia reproduction. The multimedia playback module 181 may be implemented as hardware in the controller 180 or may be implemented as software that is separate from the controller 180. The controller 180 may perform pattern recognition processing in which written input or drawing input carried out on the touch screen is recognized as a letter or as an image.

Under control of the controller 180, the power supply unit 190 receives external power or internal power and supplies power required for operation to each component.

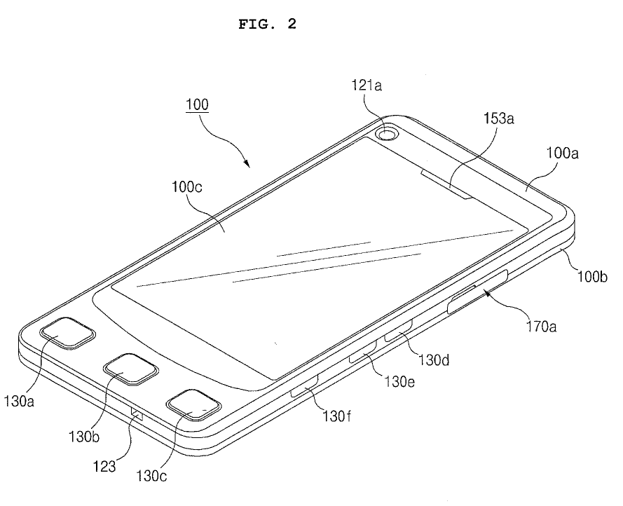

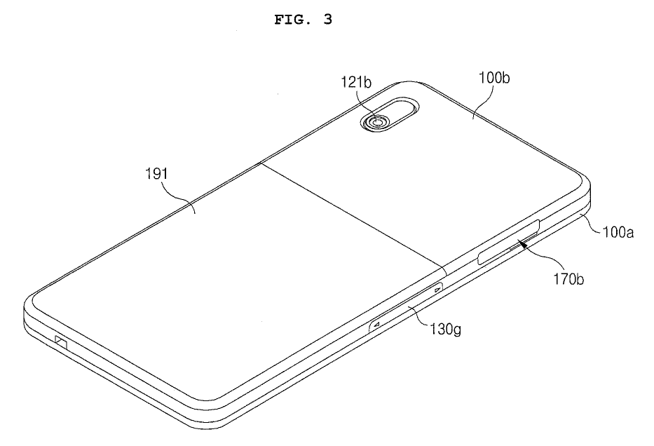

In the above description, the mobile terminal according to the present invention was described in terms of functional components thereof. Hereinafter, the mobile terminal 100 according to the present invention will be described with reference to FIGS. 2 and 3 in terms of structural components thereof. In the following description, a bar type mobile terminal having a front touch screen will be described as an example for the convenience of description. However, the present invention is not limited to such a bar type mobile terminal. For example, the present invention is applicable to other types of mobile terminals, such as a folder type mobile terminal, a swing type mobile terminal, a slide type mobile terminal, and the like.

FIG. 2 is a perspective view illustrating the front of a mobile terminal according to an embodiment of the present invention.

Referring to FIG. 2, a case forming the external appearance of the mobile terminal 100 is constituted by a front case 100a, a rear case 100b, and a display window 100c. Various electronic components are mounted in a space defined between the front case 100a and the rear case 100b. At least one middle case may be further disposed between the front case 100a and the rear case 100b. A display unit 151 is disposed below the display window 100c.

The front case 100a and the rear case 100b are made of an injection-molded synthetic resin. The front case 100a and the rear case 100b are colored by deposition, plating or spraying. The display window 100c is made of a transparent material, such as a transparent synthetic resin or transparent glass. The display window 100c may be implemented as a touchpad, which may be mounted upon the display unit 151 such that the display unit 151 can be operated as a touch screen.

At a body of the mobile terminal, specifically at the front case 1, may be disposed a first audio output module 153a, a first camera 121a, and first to third user input units 130a to 130b. The display unit 151 may be disposed below the display window 100c. At one side of the rear case 100b may be disposed fourth to sixth user input units 130d to 130f, a first interface unit 170a, and a microphone 123.

The display unit 151 includes a liquid crystal display (LCD) or an organic light emitting diode (OLED) display which visually shows information. A touchpad may overlap the display unit 151 in a layered structure such that the display unit 151 can be operated as a touch screen through which information can be input by user touch.

The first audio output module 153a may be implemented as a receiver or a speaker. The first camera 121a may be implemented to appropriately capture a still image or a moving image of the user. The microphone 123 may be implemented to appropriately receive voice of the user or other sounds.

The first to sixth user input units 130a to 130f may be simply referred to as a user input unit 130. Types of the user input unit 130 are not particularly restricted as long as the user input unit 130 can be operated in a tactile manner in which the user manipulates the user input unit 130 in a tactile sensation.

For example, the user input unit 130 may be implemented as a dome switch or a touchpad which receives a command or information through user manipulation, such as push or touch. Alternatively, the user input unit 130 may be implemented as a wheel, a jog wheel or a joystick which can rotate a key. In a functional aspect, the first to third user input units 130a to 130c are provided to input commands such as start, stop, and communication, and the fourth to sixth user input units 130d to 130f may serve as hot keys to select operation modes or activate special functions.

The first interface unit 170a may serve as a channel through which the mobile terminal 100 can exchange data with external devices. The first interface unit 170a may be a card socket which receives an external card, such as a subscriber identification module (SIM), a user identity module (UIM), or a memory card for storing information.

FIG. 3 is a perspective view illustrating the rear of the mobile terminal according to the embodiment of the present invention shown in FIG. 2.

Referring to FIG. 3, a seventh user input unit 130g and a second interface unit 170b may be disposed at one side of the rear case 100b. A second camera 121b may be further mounted at the rear of the rear case 100b.

The second camera 121b may have a capture direction substantially reverse to the capture direction of the first camera 121a. Also, the second camera 121b may have a different resolution that the first camera 121a. For example, a user may capture his/her face using the first camera 121a and transmit the captured image to a communication partner during video communication. For this reason, the first camera 121a preferably has a low resolution. On the other hand, a normal subject may be captured using the second camera 121b, and the captured subject may not be immediately transmitted to the communication partner. For this reason, the second camera 121b preferably has a high resolution.

A second audio output module (not shown) may be further disposed at the rear case 100b. The second audio output module may output audio in stereo together with the second audio output module 153a. Alternatively, the second audio output module may be used for communication in a speaker phone mode.

Also, a broadcast signal receiving antenna (not shown) may be disposed at one side of the rear case 100b in addition to a communication antenna. The antenna may be mounted in the rear case 100b such that the antenna can be withdrawn from the rear case 100b.

The second interface unit 170b may be implemented in a wired or wireless fashion. The second interface unit 170b may be at least one selected from a group consisting of a connection terminal connected to an earphone, a local area communication port, and a power supply port for supplying power to the mobile terminal 100 or combinations thereof.

To the rear case 100b is coupled a power supply unit cover 191 for covering the power supply unit 190, which supplies power to the mobile terminal 100, mounted to the rear case 100b. The power supply unit 190 may be a rechargeable battery. When the power supply unit 190 is needed to be charged, the power supply unit cover 191 is removed from the rear case 100b, and the power supply unit 190 is removed from the rear case 100b. To mount the power supply unit 190 in the mobile terminal 100, the power supply unit cover 191 is removed from the rear case 100b, the power supply unit 190 is mounted to the rear case 100b so as to supply power to the mobile terminal 100, and the power supply unit cover 191 is coupled to the rear case 100b.

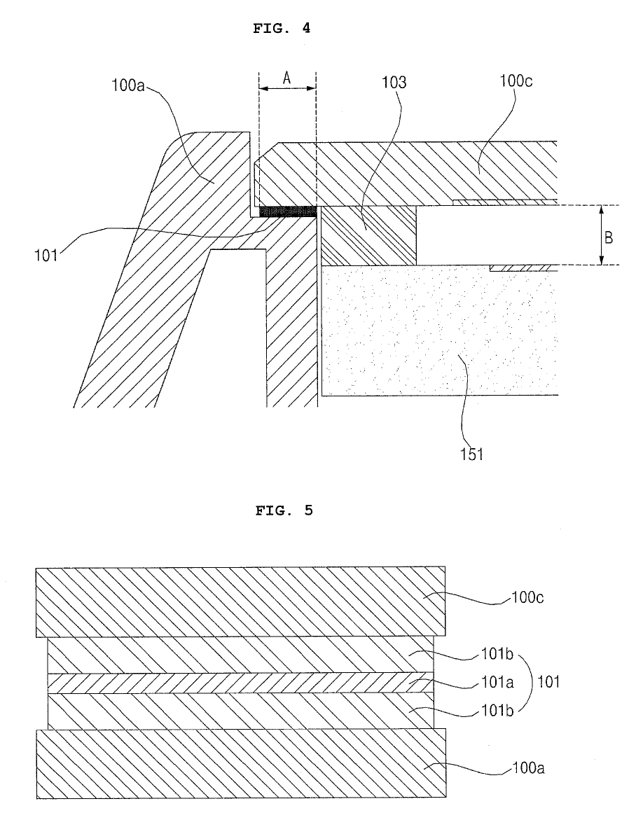

FIG. 4 is a partial sectional view illustrating the case of the mobile terminal according to the embodiment of the present invention.

Referring to FIG. 4, the front case 100a has a hole through which the display unit 151 is exposed. At the front case 100a around the hole is formed a depressed step in which the display window 100c is located. The depressed step of the front case 100a and the edge of the display window 100c are joined to each other by an adhesive tape 101. Preferably, the adhesive tape 101 has a width A of approximately 1.5 mm or more for provision of minimal adhesive force and decoration. During thermal fusion, the width of the adhesive tape 101 increases. Therefore, it is preferable for the width of the adhesive tape 101 before thermal fusion to be less than the width of the depressed step of the front case 100a.

Also, a display pad 103 may be provided such that the display window 100c is spaced apart from the display unit 151 by a distance B. Preferably, the adhesive force of the adhesive tape 101 is greater than the repulsive force of the display pad 103. Preferably, the distance B between the display window 100c and the display unit 151 is approximately 0.1 mm to approximately 0.5 mm.

FIG. 5 is a construction view illustrating the adhesive tape 101 of the mobile terminal according to the embodiment of the present invention.

Referring to FIG. 5, the adhesive tape 101 includes a metal sheet 101a configured to be induction heated by a high frequency and thermal fusion tape parts 101b stacked on opposite main surfaces of the metal sheet 101a such that the thermal fusion tape parts 101b can be thermally fused to predetermined members by the heated metal sheet 101a. In this embodiment, the members are the front case 100a and the display window 100c.

The metal sheet 101a is high-frequency induction heated. Induction heating is a method of applying an alternating current electromagnetic field to a conductive material to increase the temperature of the material. Preferably, the metal sheet 101a is made of a conductive metal material that can be induction heated. Also preferably, the metal sheet 101a is made of a metal material which is light, soft, and can be easily processed. In this embodiment, the metal sheet 101a is made of aluminum.

Each of the thermal fusion tape parts 101b is a bonding agent the adhesive property of which can be created or increased when the bonding agent is heated. Each of the thermal fusion tape parts 101b may be made of a combination of an adhesive polymer and a thermoplastic resin. For example, each of the thermal fusion tape parts 101b may be made of a synthetic resin, such as polyester, polyurethane, nitrile rubber, or a phenol resin, and combinations thereof.

In this embodiment, the members to which the adhesive tape 101 is to be bonded are the front case 101a and the display window 100c. The members may be other cases or decorative elements of the mobile terminal 100. The members do not need to be made of a metal material that can transmit heat necessary for thermal fusion. That is, the members may be made of a nonmetal material. Preferably, the members are made of a nonmetal material that is not induction heated.

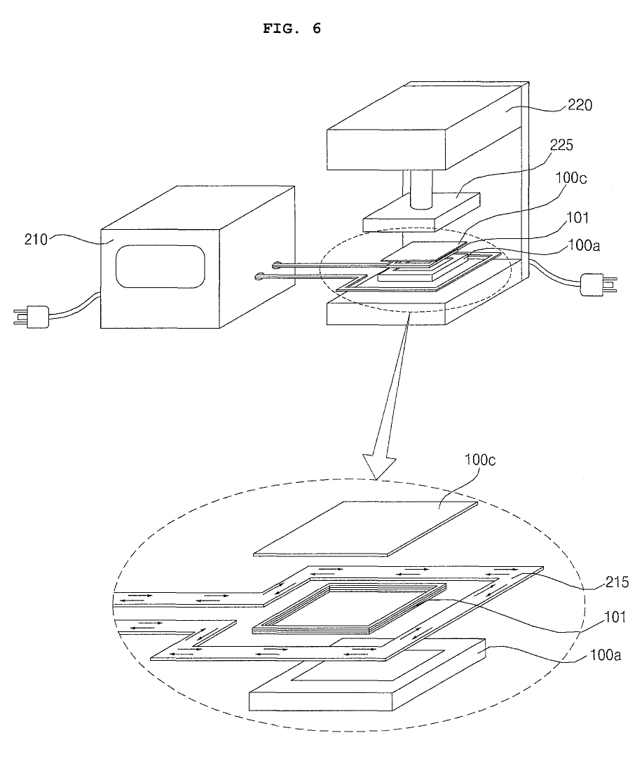

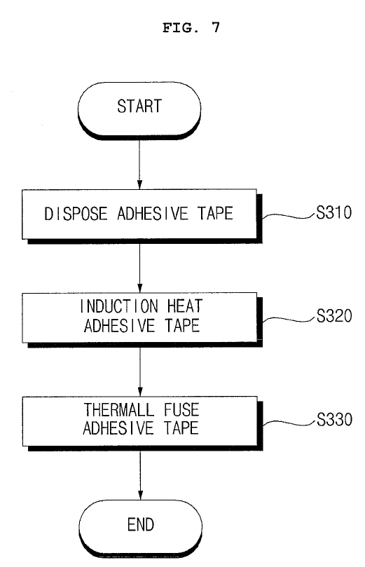

FIG. 6 is a view illustrating a manufacturing apparatus of the mobile terminal according to the embodiment of the present invention.

Referring to FIG. 6, the manufacturing apparatus of the mobile terminal includes a high frequency generation device 210 for applying a high frequency to an adhesive tape 101 in a state in which the adhesive tape 101 is disposed between predetermined members to which the adhesive tape 101 is to be bonded and a pressing device 220 for applying pressure to the members when the adhesive tape 101 is heated and thermally fused to the members. In this embodiment, the members are the front case 100a and the display window 100c.

The high frequency generation device 210 applies an alternating current to a high frequency generation coil 215 to generate a high frequency. When the high frequency generation device 210 applies a high-frequency alternating current to the high frequency generation coil 215, the high frequency generation coil 215 generates a high-frequency electromagnetic field according to a principle of electromagnetic induction.

When the high-frequency electromagnetic field is generated by the high frequency generation device 210, the metal sheet 101a of the adhesive tape 101 is induction heated. When the metal sheet 101a is heated, the thermal fusion tape parts 101b are fused to the members, i.e., the front case 100a and the display window 100c.

The pressing device 220 applies pressure to the members using a pressing plate 225. When the adhesive tape 101 is fused to the members, i.e., the front case 100a and the display window 100c, the pressing device 220 applies pressure to the members, i.e., the front case 100a and the display window 100c, using the pressing plate 225. The pressing device 220 may apply pressure to the members before the adhesive tape 101 is induction heated by the high frequency generation device 210, while the adhesive tape 101 is induction heated by the high frequency generation device 210, after the adhesive tape 101 is induction heated by the high frequency generation device 210. Preferably, the pressing device 220 applies pressure to the members before the adhesive tape 101 is induction heated by the high frequency generation device 210 until the members are sufficiently cooled. Preferably, the pressing device 220 applies pressure to the members when the thermal fusion tape parts 101b of the adhesive tape 101 are thermally fused to the front case 100a and the display window 100c.

The pressing device 220 places the adhesive tape 101 at an adhesion position between the members, i.e., the front case 100a and the display window 100c. Preferably, the pressing device 220 has a jig for guiding the adhesive tape 101 such that the adhesive tape 101 is not placed at the wrong adhesion position between the members due to misalignment between the adhesive tape 101 and the members before or when the pressure is applied by the pressing device 220.

The pressing device 220 may perform temporary bonding such that the adhesive tape 101 is disposed at a correct position of the front case 100a. Since the width of the adhesive tape 101 before thermal fusion is less than the width of the depressed step of the front case 100a, the adhesive tape 101 may be incorrectly disposed. For this reason, the pressing device 220 applies pressure to the adhesive tape 101 and the front case 100a after the adhesive tape 101 is disposed at the front case 100a so as to temporarily bond the adhesive tape 101 to the front case 100a. Upon temporary bonding, heat may be applied to the adhesive tape 101. Preferably, the adhesive tape 101 has release paper attached to a side where the adhesive tape 101 is bonded to the display window 100c upon temporary bonding. Also preferably, a hole for fixing a temporary bonding position is formed at the release paper.

FIG. 7 is a flow chart illustrating a manufacturing method of the mobile terminal according to the embodiment of the present invention.

The adhesive tape 101 is disposed at the predetermined members (S310). The pressing device 220 may guide the adhesive tape 101 such that the adhesive tape 101 can be disposed at a predetermined adhesion position between the members, i.e., the front case 100a and the display window 100c. When the adhesive tape 101 is disposed at the adhesion position between the members, i.e., the front case 100a and the display window 100c, the pressing device 220 preferably applies pressure to the members, i.e., the front case 100a and the display window 100c. The pressing device 220 may temporarily bond the adhesive tape 101 to the front case 100a before the disposition of the display window 100c.

The adhesive tape 101 is induction heated (S320). When the high frequency generation device 210 applies a high-frequency alternating current to the high frequency generation coil 215, the high frequency generation coil 215 generates a high-frequency electromagnetic field. When the high-frequency electromagnetic field is generated by the high frequency generation device 210, the metal sheet 101a of the adhesive tape 101 is induction heated.

The adhesive tape 101 is thermally fused (S330). When the metal sheet 101a of the adhesive tape 101 is heated, the thermal fusion tape parts 101b of the adhesive tape 101 are fused to the members, i.e., the front case 100a and the display window 100c.

Upon completion of thermal fusion, the high frequency generation device 210 stops generation of a high frequency such that the members and the adhesive tape 101 can cool down. Preferably, pressure is continuously applied by the pressing device 220 until the members, i.e., the front case 100a and the display window 100c, have cooled sufficiently. An additional cooling device is not needed. When the cooling device is used, however, it is possible to reduce adhesion time. Upon completion of cooling, application of pressure by the pressing device 220 is stopped.

The adhesive tape, the mobile terminal including the same, and the manufacturing method and apparatus of the mobile terminal according to the present invention are not limited to the construction and operation disclosed in the embodiments as described above. All or some of the embodiments may be selectively combined to provide various modifications.

As is apparent from the above description, the adhesive tape, the mobile terminal including the same, and the manufacturing method and apparatus of the mobile terminal according to the present invention have one or more effects as described below.

First, it is possible to provide higher adhesive strength than a conventional double-sided adhesive tape or a conventional bonding agent when components are joined by the adhesive tape according to the present invention, thereby preventing separation between the window and the case.

Second, nonmetal members are bonded to each other by thermal fusion.

Third, heat is not directly applied to the members, and therefore, deformation of the members is minimal.

Fourth, adhesive strength is increased, and deformation is decreased, thereby improving productivity and reducing material cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An adhesive tape comprising:
a metal sheet configured to be high-frequency induction heated; and
thermal fusion tape parts stacked on opposite main surfaces of the metal sheet such that the thermal fusion tape parts can be thermally fused to predetermined members by the heated metal sheet.

2. The adhesive tape according to claim 1, wherein the metal sheet is made of aluminum.

3. The adhesive tape according to claim 1, wherein each of the members is made of a nonmetal material.

4. The adhesive tape according to claim 1, wherein each of the thermal fusion tape parts is made of a combination of an adhesive polymer and a thermoplastic resin.

5. A mobile terminal comprising:
a nonmetal case forming an external appearance of the mobile terminal;
a nonmetal member bonded to the case; and
an adhesive tape for bonding the member to the case, wherein the adhesive tape comprises:
a metal sheet configured to be heated by a high frequency; and
thermal fusion tape parts stacked on opposite main surfaces of the metal sheet such that the thermal fusion tape parts can be thermally fused to the case and the member by the heated metal sheet.

6. The mobile terminal according to claim 5, wherein the member comprises a transparent display window.

7. The mobile terminal according to claim 5, further comprising:
a display unit provided in the case for displaying information on a screen, wherein
the case has a hole through which the display unit is exposed, and a depressed step in which the member is located around the hole, and
the adhesive tape joins the depressed step of the case and an edge of the member to each other.

8. The mobile terminal according to claim 7, further comprising a display pad for separating the member from the display unit such that the member is spaced apart from the display unit by a predetermined distance.

9. The mobile terminal according to claim 5, wherein each of the thermal fusion tape parts is made of a combination of an adhesive polymer and a thermoplastic resin.

10. A manufacturing method of a mobile terminal, comprising:
disposing an adhesive tape between predetermined members;
applying a high frequency to the adhesive tape to heat the adhesive tape; and
thermally fusing the heated adhesive tape to the members.

11. The manufacturing method according to claim 10, wherein the step of disposing the adhesive tape between the members comprises applying pressure to the members.

12. The manufacturing method according to claim 10, wherein the step of disposing the adhesive tape between the members comprises:
temporarily bonding the adhesive tape to one of the members; and
disposing the other member at the temporarily bonded adhesive tape.

13. The manufacturing method according to claim 10, wherein the adhesive tape comprises:
a metal sheet configured to be heated by a high frequency; and
thermal fusion tape parts stacked on opposite main surfaces of the metal sheet such that the thermal fusion tape parts can be thermally fused to the members by the heated metal sheet.

14. The manufacturing method according to claim 13, wherein each of the thermal fusion tape parts is made of a combination of an adhesive polymer and a thermoplastic resin.

15. The manufacturing method according to claim 10, wherein the members comprise a nonmetal case forming an external appearance of the mobile terminal and a transparent display window bonded to the case.

16. A manufacturing apparatus of a mobile terminal, comprising:
a high frequency generation device for applying a high frequency to an adhesive tape in a state in which the adhesive tape is disposed between predetermined members to heat the adhesive tape; and
a pressing device for applying pressure to the members when the adhesive tape is heated and thermally fused to the members.

17. The manufacturing apparatus according to claim 16, wherein the pressing device applies pressure to the members before the high frequency generation device applies a high frequency to the adhesive tape.

18. The manufacturing apparatus according to claim 16, wherein the adhesive tape comprises:
a metal sheet configured to be heated by a high frequency generated by the high frequency generation device; and
thermal fusion tape parts stacked on opposite main surfaces of the metal sheet such that the thermal fusion tape parts can be thermally fused to the members by the heated metal sheet.

19. The manufacturing apparatus according to claim 18, wherein each of the thermal fusion tape parts is made of a combination of an adhesive polymer and a thermoplastic resin.

20. The manufacturing apparatus according to claim 16, wherein the members comprise a nonmetal case forming an external appearance of the mobile terminal and a transparent display window bonded to the case.
